(19) United States
(12) Patent Application Publication
(10) Pub. No.: US 2017/0150487 A1
(43) Pub. Date: May 25, 2017

(54) METHOD AND APPARATUS FOR CONFIGURING RESOURCE AND COMMUNICATIONS SYSTEM

(71) Applicant: FUJITSU LIMITED, Kawasaki-shi (JP)

(72) Inventors: Hua ZHOU, Beijing (CN); Yi ZHANG, Beijing (CN)

(73) Assignee: FUJITSU LIMITED, Kawasaki-shi (JP)

(21) Appl. No.: 15/426,786

(22) Filed: Feb. 7, 2017

Related U.S. Application Data
(63) Continuation of application No. PCT/CN2014/084521, filed on Aug. 15, 2014.

(51) Int. Cl. H04W 72/04; H04W 72/12; H04B 7/06; H04B 7/0417

(52) U.S. Cl. CPC H04W 72/046; H04B 7/0417; H04W 72/1226; H04B 7/0626

(57) ABSTRACT

A method and apparatus for configuring a resource and a communications system. The method includes: a base station configures a first type of beams and a second type of beams having different beam widths; and broadcasts beam configuration information to user equipment. The user equipment performs beam measurement according to the beam configuration information broadcasted by the base station, and feeds back channel information on the first type of beams and the second type of beams. With the embodiments of this disclosure, the base station having multiple antennas may to serve for different pieces of user equipment within a cell by flexibly using multiple beam widths and different beam directions, so as to improve an average throughput of the cell.

### CROSS REFERENCE TO RELATED APPLICATIONS

This application is a continuation application of International Application PCT/CN2014/084521 filed on Aug. 15, 2014, the entire contents of which are incorporated herein by reference.

### TECHNICAL FIELD

The present disclosure relates to the field of communications, and in particular to a method and apparatus for configuring a resource and a communications system in a three-dimensional (3D) multiple input multiple output (MIMO) system.

### BACKGROUND

As the development of antenna technologies, a large amount of antennas may be arranged in a transmitting device. Three-dimensional beamforming technology of multiple antennas may improve antenna gains, flexibly configure beam widths and directions according to distribution of user equipment (UE), efficiently suppress white noises and inter-cell random interference and improve efficiency and reliability of system transmission, which is a hot candidate technology for future mobile communications systems.

It should be noted that the above description of the background is merely provided for clear and complete explanation of the present disclosure and for easy understanding by those skilled in the art. And it should not be understood that the above technical solution is known to those skilled in the art as it is described in the background of the present disclosure.

### SUMMARY

However, it was found by the inventors that there exists no solution for configuring and feeding back a reference signal based on the beamforming in the prior art, and a base station having multiple antennas is unable to serve for different pieces of user equipment within a cell by flexibly using multiple beam widths and different beam directions.

Embodiments of this disclosure provide a method and apparatus for configuring a resource and a communications system, in which by configuring reference signal resources of multiple beam widths, multiple pieces of user equipment within the system may be served for by using multiple beam widths.

According to a first aspect of the embodiments of the present disclosure, there is provided a method for configuring a resource, applicable to a base station of a 3D MIMO system, the method including:

configuring a first type of beams and a second type of beams having different beam widths by a base station; the first type of beams and the second type of beams are transmitted in resources of one or more reference signals, the reference signal being pre-coded by one or more weighting coefficients of a beam; and

broadcasting beam configuration information by the base station to user equipment, the beam configuration information at least including identification information of a beam and physical resource information of the beam.

According to a second aspect of the embodiments of the present disclosure, there is provided an apparatus for configuring a resource, configured in a base station of a 3D MIMO system, the apparatus including:

a configuring unit configured to configure a first type of beams and a second type of beams having different beam widths; the first type of beams and the second type of beams are transmitted in resources of one or more reference signals, the reference signal being pre-coded by one or more weighting coefficients of a beam; and

an information transmitting unit configured to broadcast beam configuration information to user equipment, the beam configuration information at least including identification information of a beam and physical resource information of the beam.

According to a third aspect of the embodiments of the present disclosure, there is provided a method for configuring a resource, applicable to user equipment of a 3D MIMO system, the method including:

receiving, by the user equipment, beam configuration information broadcasted by a base station, the beam configuration information at least including identification information of a beam and physical resource information of the beam; and

measuring a first type of beams and a second type of beams having different beam widths configured by the base station; the first type of beams and the second type of beams are transmitted in resources of one or more reference signals, the reference signal being pre-coded by one or more weighting coefficients of a beam.

According to a fourth aspect of the embodiments of the present disclosure, there is provided an apparatus for configuring a resource, configured in user equipment of a 3D MIMO system, the apparatus including:

an information receiving unit configured to receive beam configuration information broadcasted by a base station, the beam configuration information at least including identification information of a beam and physical resource information of the beam; and

a beam measuring unit configured to measure a first type of beams and a second type of beams having different beam widths configured by the base station; the first type of beams and the second type of beams are transmitted in resources of one or more reference signals, the reference signal being pre-coded by one or more weighting coefficients of a beam.

According to a first aspect of the embodiments of the present disclosure, there is provided a communications system, including:

a base station configured with the apparatus for configuring a resource as described above; and

user equipment configured with the apparatus for configuring a resource as described above.

According to another aspect of the embodiments of the present disclosure, there is provided a computer readable program code, which, when executed in a base station, will cause a computer unit to carry out the method for configuring a resource as described above in the base station.

According to a further aspect of the embodiments of the present disclosure, there is provided a computer readable medium, including a computer readable program code, which will cause a computer unit to carry out the method for configuring a resource as described above in a base station.

According to still another aspect of the embodiments of the present disclosure, there is provided a computer readable program code, which, when executed in user equipment, will cause a computer unit to carry out the method for configuring a resource as described above in the user equipment.

According to yet another aspect of the embodiments of the present disclosure, there is provided a computer readable medium, including a computer readable program code, which will cause a computer unit to carry out the method for configuring a resource as described above in user equipment.

An advantage of the embodiments of the present disclosure exists in that by configuring reference signal resources of multiple beam widths, multiple pieces of user equipment within the system may be served for by using multiple beam widths. Hence, the base station having multiple antennas may serve for different pieces of user equipment within a cell by flexibly using multiple beam widths and different beam directions, so as to improve an average throughput of the cell.

With reference to the following description and drawings, the particular embodiments of the present disclosure are disclosed in detail, and the principle of the present disclosure and the manners of use are indicated. It should be understood that the scope of the embodiments of the present disclosure is not limited thereto. The embodiments of the present disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of serving for one piece of user equipment by multiple narrow beams of an embodiment of this disclosure;

FIG. 2 is a schematic diagram of serving for one piece of user equipment by one wide beam of an embodiment of this disclosure;

FIG. 3 is a schematic diagram of serving for multiple pieces of user equipment by multiple narrow beams of an embodiment of this disclosure;

FIG. 4 is a schematic diagram of serving for multiple pieces of user equipment by one wide beam of an embodiment of this disclosure;

FIG. 5 is a flowchart of the method for configuring a resource of Embodiment 1 of this disclosure;

FIG. 6 is another flowchart of the method for configuring a resource of Embodiment 1 of this disclosure;

FIG. 7 is a flowchart of the method for configuring a resource of Embodiment 2 of this disclosure;

FIG. 8 is a schematic diagram of a structure of the apparatus for configuring a resource of Embodiment 3 of this disclosure;

FIG. 9 is a schematic diagram of a structure of the base station of Embodiment 3 of this disclosure;

FIG. 10 is a schematic diagram of a structure of the apparatus for configuring a resource of Embodiment 4 of this disclosure;

FIG. 11 is a schematic diagram of a structure of the user equipment of Embodiment 4 of this disclosure; and

FIG. 12 is a schematic diagram of a structure of the communications system of Embodiment 5 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims. Various embodiments of the present disclosure shall be described below with reference to the accompanying drawings.

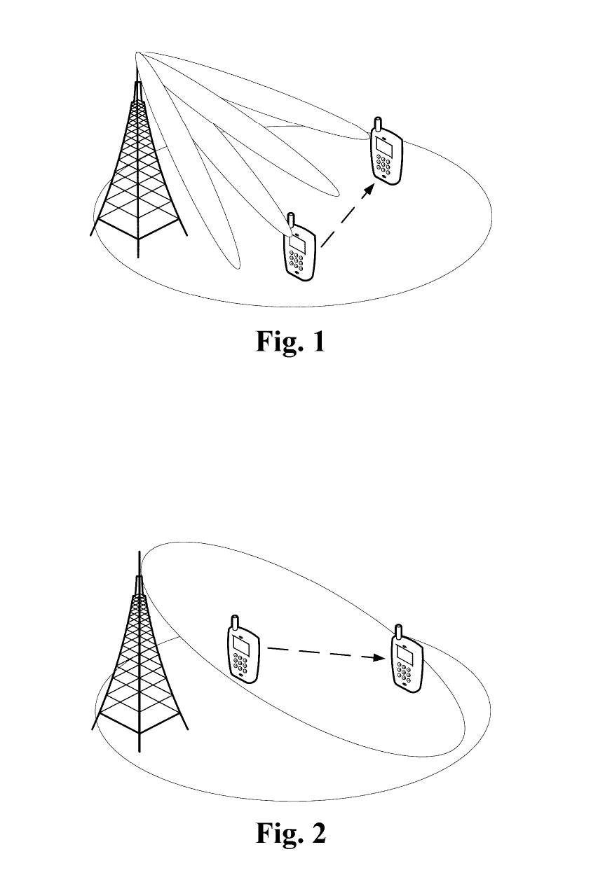

In a 3D MIMO system, a beam changes as a change of user equipment, and provides relatively good services for the user equipment. FIG. 1 is a schematic diagram of serving for one piece of user equipment by multiple narrow beams of an embodiment of this disclosure. As shown in FIG. 1, the user equipment moves from one position to another, and a base station may use different narrow beams directed to different beam directions to serve for the user equipment, that is, it switches different beams for serving for the user equipment.

FIG. 2 is a schematic diagram of serving for one piece of user equipment by one wide beam of an embodiment of this disclosure. As shown in FIG. 2, when a moved distance and direction of the user equipment are insufficient for that the user equipment is served by narrow beams of different beams direction, the base station may serve for the user equipment by using one or more wide beams of relatively large beam widths; in this way, the beam directions need not to be switched.

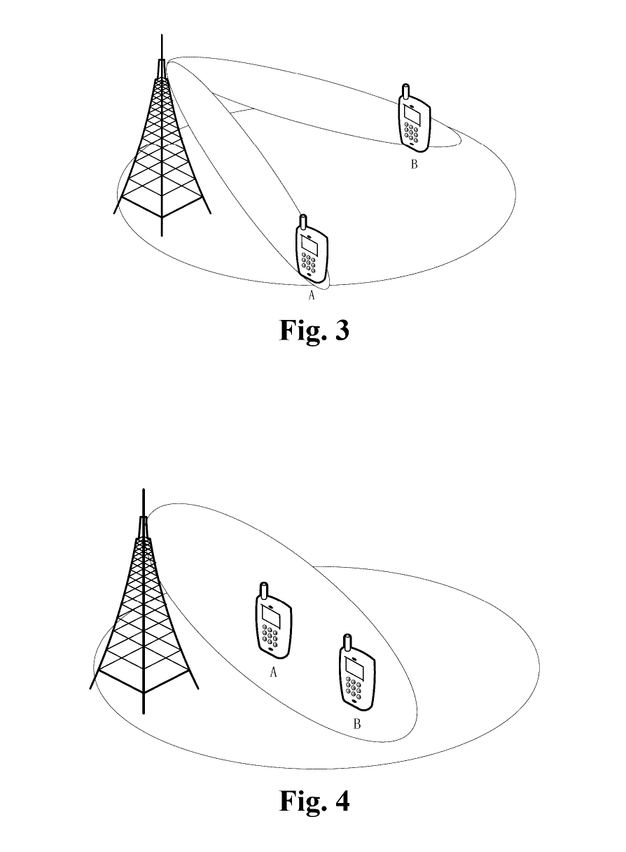

FIG. 3 is a schematic diagram of serving for multiple pieces of user equipment by multiple narrow beams of an embodiment of this disclosure. As shown in FIG. 3, two pieces of user equipment are located at different spatial positions in a cell, and the base station may serve for the two pieces of user equipment by using different narrow beams directed to different beam directions, that is, serving for two different pieces of user equipment by using different beams.

FIG. 4 is a schematic diagram of serving for multiple pieces of user equipment by one wide beam of an embodiment of this disclosure. As shown in FIG. 4, when positions and directions of two pieces of user equipment are insufficient for that the user equipment is served by narrow beams of different beams direction, the base station may serve for the two pieces of user equipment by using wide beams of relatively large beam widths, in which case the base station may differentiate data transmitted to different user equipment by using different physical resources.

Scenarios of the embodiment of this disclosure are illustrated above; however, this disclosure is not limited thereto. In order to achieve beam selection in different scenarios, it is needed that the base station at a transmitting side and user equipment at a receiving side are designed jointly. Embodiments of this disclosure shall be described below in detail.

### Embodiment 1

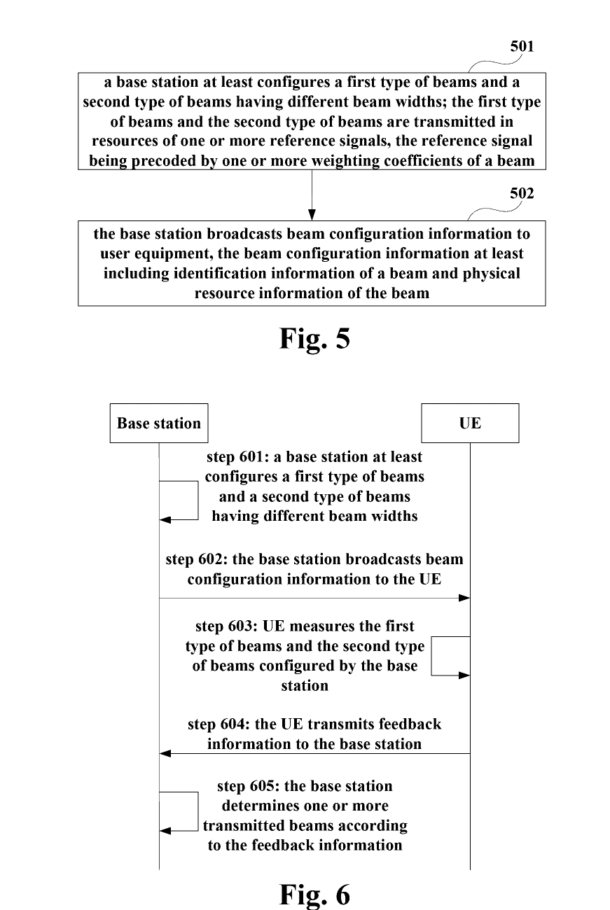

An embodiment of this disclosure provides a method for configuring a resource, applicable to a base station of a 3D MIMO system. FIG. 5 is a flowchart of the method for configuring a resource of the embodiment of this disclosure. As shown in FIG. 5, at a base station side, the method for configuring a resource includes:

step 501: a base station at least configures a first type of beams and a second type of beams having different beam widths; the first type of beams and the second type of beams are transmitted in resources of one or more reference signals, the reference signal being pre-coded by one or more weighting coefficients of a beam; and

step 502: the base station broadcasts beam configuration information to user equipment, the beam configuration information at least including identification information of a beam and physical resource information of the beam.

In this embodiment, the first type of beams and the second type of beams may have multiple different directions. For example, the first type of beams may be wide beams having multiple different directions, and the second type of beams may be narrow beams having multiple different directions.

In this embodiment, the reference signal may include: a channel state information reference signal (CSI-RS), and/or a common reference signal (CRS), and/or a specific demodulation reference signal (DMRS), and/or other reference signals used for measuring a channel by a terminal; however, this disclosure is not limited thereto; for example, it may be other reference signals. Following description shall be given taking a CSI-RS as an example.

In this embodiment, the base station may broadcast the beam configuration information, so that the user equipment may measure the beams according to the beam configuration information. The beam configuration information at least includes identification information of a beam (such as a beam index) and physical resource information of the beam. However, this disclosure is not limited thereto; for example, it may further include other information.

In this embodiment, the base station may select a network coverage of multiple beam widths according to a network configuration condition. For example, multiple beams (total 360/10=36 beams) of very small beam widths (referred to as narrow beams, such as 10 degrees, which are examples only, and other widths may also be used) may be configured for covering a served region; and at the same time, a few beams (total 360/60=6 beams) of very large beam widths (referred to as wide beams, such as 60 degrees, which are examples only, and other widths may also be used) may be configured for covering the served region.

Furthermore, beams of different beam widths may also be configured in this embodiment for serving for specific user equipment, such as configuring only one wide beam (such as 60 degrees) and six narrow beams (such as 10 degrees). Or, only one wide beam and one narrow beam are configured. Configuration of wide beams and narrow beams may be flexibly determined according to an actual situation. Furthermore, two types of beams are at least configured in the embodiment of this disclosure. However, it is not limited thereto, and more types of beams of different beam widths and beam directions may also be configured, such as configuring a first type of beams of 10 degrees, a second type of beams of 30 degrees, and a third type of beams of 60 degrees, etc. Following description shall be given taking configuring multiple wide beams and multiple narrow beams as an example.

In an implementation, the multiple first type of beams employ identical physical resources, and the multiple second type of beams employ another group identical physical resources, the physical resources employed by the first type of beams being orthogonal to those employed by the second type of beams.

In particular, for the sake of convenience of measurement by the user equipment, the narrow beams and the wide beams may be differentiated by orthogonal physical resources, such as a time domain, a frequency domain, or a code domain. One of them may be used; for example, the narrow beams and the wide beams are transmitted at different time, or transmitted in different frequency resources, or multiplexed in different orthogonal codes and transmitted, or they may be used in a combined manner. Furthermore, in differentiating different beam directions (no matter the narrow beams or the wide beams), the base station may pre-code CSI-RSs by using different weighing vectors (weighting coefficients of the beams), so as to form beamforming in different directions. Such configuration may lower the number of the physical resources occupied by the CSI-RSs.

In this implementation, the multiple first type of beams are differentiated by using different precoding information, and the multiple second type of beams are differentiated by using different precoding information. And besides broadcasting the identification information of the beams and the physical resource information of the beams, the base station may also broadcast the precoding information.

In particular, for different CSI-RS resource configuration, the base station determines whether to notify the user equipment of the weighting precoding information of the CSI-RSs. If multiple beams of the same beam width are differentiated in different precoding weighting manners, the base station needs to notify the user equipment of the precoding information.

In another implementation, the multiple first type of beams and the multiple second type of beams use different physical resources, and the physical resources occupied by different beams are orthogonal to each other (by using one of a time domain, a frequency domain, or a code domain, or a combination thereof, for example).

In particular, in configuring the CSI-RSs of multiple beam widths, the base station may further differentiate all the narrow beam and wide beams of different beam widths and beam directions by using orthogonal physical resources, and in different physical resources, the base station pre-codes the CSI-RSs by using different weighting vectors, so as to form beamforming of different beam directions and beam widths. Such configuration needs to occupy a relatively large number of physical resources.

In particular, for different CSI-RS resource configuration, the base station determines whether to notify the user equipment of weighting precoding information on the CSI-RSs. If multiple beams are differentiated by using different physical resources, the base station needs not to notify the user equipment of the precoding information.

In this embodiment, the user equipment may measure the first type of beams and the second type of beams of different beam widths configured by the base station, such as measuring channel station information (CSI) of multiple beams. Following embodiments may be referred to for the measurement by the user equipment.

In this embodiment, the base station may further transmit indication information to the user equipment via signaling, indicating the user equipment to feed back according to a required feedback content. And the user equipment feeds back as the required feedback content according to the indication information.

In particular, the user equipment performs CSI feedback according to the feedback content required by the base station.

FIG. 6 is another flowchart of the method for configuring a resource of the embodiment of this disclosure. As shown in FIG. 6, the method includes:

step 601: a base station at least configures a first type of beams and a second type of beams having different beam widths; and

step 602: the base station broadcasts beam configuration information to the user equipment.

Particular contents of steps 601 and 602 are as those described in steps 501 and 502.

As shown in FIG. 6, the method may further include:

step 603: user equipment measures the first type of beams and the second type of beams configured by the base station; and

step 604: the user equipment transmits feedback information to the base station.

In this embodiment, the base station receives the feedback information transmitted by the user equipment, the feedback information being obtained by the user equipment by measuring the first type of beams and the second type of beams. According to the feedback content required by the base station, there may be following types of feedback:

channel state information of all the beams configured by the base station, and beam identification information to which each piece of the channel state information corresponds; for example, the user equipment feeds back CSI to which all the measured wide beams and narrow beams correspond and each beam index to which each piece of CSI corresponds; and a feedback amount required by such feedback is maximum, and the information is most complete;

or, channel state information of a first type of beam with a best measurement result and corresponding beam identification information, and channel state information of a second type of beam with a best measurement result and corresponding beam identification information; for example, the user equipment feeds back CSI to which a best wide beam and a best narrow beam correspond, and corresponding beam indexes; and such feedback respectively feeds back best beams in different beam widths;

or, channel state information of a first type of beam with a best measurement result and corresponding beam identification information, and channel state information of multiple second type of beams with best measurement results and corresponding beam identification information; for example, the user equipment feeds back CSI to which a best wide beam corresponds, CSI to which one or more best narrow beams correspond, and corresponding beam indexes;

or, channel state information of a first type of beam with a best measurement result and corresponding beam identification information, and average channel state information of multiple second type of beams; for example, the user equipment feeds back CSI to which a best wide beam corresponds, average CSI corresponding to multiple narrow beams, and a beam index to which the wide beam corresponds.

As shown in FIG. 6, the method for configuring a resource may further include:

step 605: the base station determines one or more transmitted beams according to the feedback information.

In this embodiment, the base station may perform scheduling according to feedback information transmitted by one or more pieces of the user equipment.

For example, the base station may schedule multiple pieces of the user equipment in the same physical resource according to CSI fed back by the user equipment, only if indices of the beams fed back by the user equipment are different, that is, it means that these pieces of the user equipment may be differentiated by using different beam directions. In particular, the following methods may be used:

serving for multiple pieces of user equipment by using the same beam if beam identification of the second type of beams fed back by the multiple pieces of user equipment is identical and beam identification of the first type of beams fed back by the multiple pieces of user equipment is also identical; for example orthogonal physical resources are used to differentiate the multiple pieces of user equipment;

for example, if indices of narrow beams fed back by the multiple pieces of user equipment are identical and indices of wide beams are also identical, the multiple pieces of user equipment may be scheduled in the same beam (a narrow beam or a wide beam), and different pieces of user equipment are differentiated by using orthogonal physical resources (a time domain or a frequency domain);

serving for the multiple pieces of user equipment by using different first type of beams if beam identification of the second type of beams fed back by the multiple pieces of user equipment is identical and beam identification of the first type of beams fed back by the multiple pieces of user equipment is different;

for example, if indices of narrow beams fed back by the multiple pieces of user equipment are identical and indices of wide beams are different, the user equipment may be served by using different wide beams;

serving for the multiple pieces of user equipment by using different second type of beams, or serving for the multiple pieces of user equipment by using the same first type of beam, if beam identification of the second type of beams fed back by the multiple pieces of user equipment is different and beam identification of the first type of beams fed back by the multiple pieces of user equipment is identical; for example orthogonal physical resources are used to differentiate the multiple pieces of user equipment;

for example, if indices of narrow beams fed back by the multiple pieces of user equipment are different and indices of wide beams are identical, the user equipment may be served by using different narrow beams, or, taking that the base station employs a fallback mode into account, the base station may employ one wide beam to serve for the user equipment, but conventional orthogonal physical resources (a time domain or a frequency domain) are used to differentiate different pieces of user equipment;

and serving for the multiple pieces of user equipment by using different first type of beams, or serving for the multiple pieces of user equipment by using different second type of beam, if beam identification of the second type of beams fed back by the multiple pieces of user equipment is different and beam identification of the first type of beams fed back by the multiple pieces of user equipment is also different;

for example, if indices of narrow beams and wide beams fed back by the multiple pieces of user equipment are all different, the user equipment may be served by using different narrow beams, or by using different wide beams.

It can be seen from the above embodiment that by configuring reference signal resources of multiple beam widths, multiple pieces of user equipment within the system may be served for by using multiple beam widths. Hence, the base station having multiple antennas may serve for different pieces of user equipment within a cell by flexibly using multiple beam widths and different beam directions, so as to improve an average throughput of the cell.

### Embodiment 2

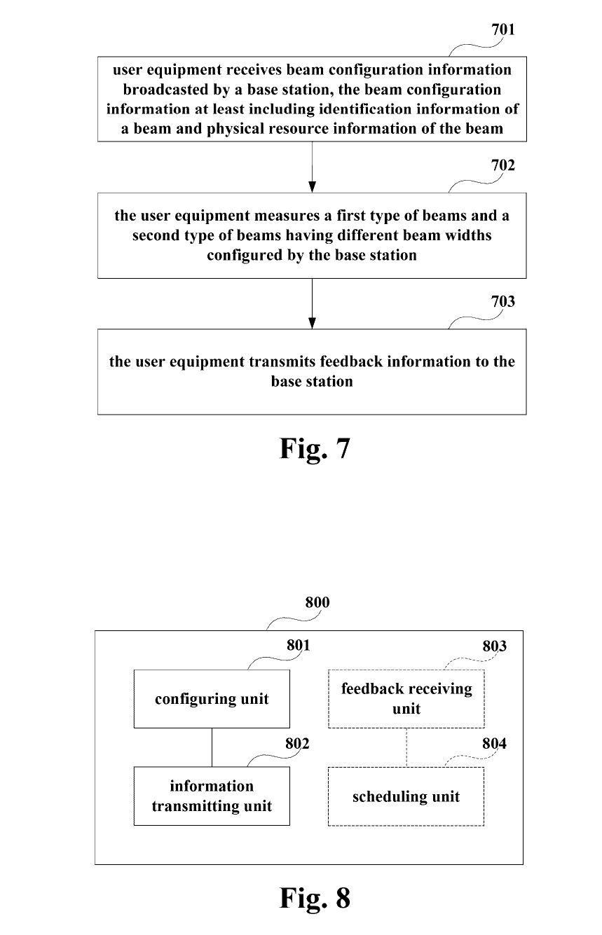

An embodiment of this disclosure provides a method for configuring a resource, applicable to user equipment of a 3D MIMO system, with contents identical to those in Embodiment 1 being not going to be described herein any further. FIG. 7 is a flowchart of the method for configuring a resource of the embodiment of this disclosure. As shown in FIG. 7, at a user equipment side, the method for configuring a resource includes:

step 701: user equipment receives beam configuration information broadcasted by a base station, the beam configuration information at least including identification information of a beam and physical resource information of the beam; and

step 702: the user equipment measures a first type of beams and a second type of beams having different beam widths configured by the base station; the first type of beams and the second type of beams are transmitted in resources of one or more reference signals, the reference signal being pre-coded by one or more weighting coefficients of the beam.

In this embodiment, each piece of user equipment may measure the beams transmitted by the base station according to a configured reference signal (such as a CSI-RS).

In particular, if different beams are differentiated by using different physical resources, the user equipment may measure CSI to which configured wide beams correspond according to physical resources occupied by the wide beams (such as positions of symbols and positions of subcarriers in a subframe of a signal), and obtain CSI of all the beams by measuring signals in all CSI-RSs. And if different beams are differentiated by using precoding weighting, the user equipment may respectively measure CSI on beams to which precoding matrices correspond according to information on the precoding matrices (precoding information) broadcasted by the base station.

As shown in FIG. 7, the method may further include:

step 703: the user equipment transmits feedback information to the base station, the feedback information being obtained by measuring the first type of beams and the second type of beams by the user equipment.

For example, the user equipment feeds back channel state information (CSI) of multiple beams.

In this embodiment, the user equipment may further receive indication information transmitted by the base station via signaling, and transmit the feedback information according to a feedback content required by the indication information. For example, the feedback information may include: channel state information of all the beams configured by the base station, and beam identification information to which each piece of channel state information corresponds;

or, channel state information of a first type of beams with a best measurement result and corresponding beam identification information, and channel state information of a second type of beams with a best measurement result and corresponding beam identification information;

or, channel state information of a first type of beams with a best measurement result and corresponding beam identification information, and channel state information of multiple second type of beams with best measurement results and corresponding beam identification information;

or, channel state information of a first type of beams with a best measurement result and corresponding beam identification information, and average channel state information of multiple second type of beams.

It can be seen from the above embodiment that by configuring reference signal resources of multiple beam widths, multiple pieces of user equipment within the system may be served for by using multiple beam widths. Hence, the base station having multiple antennas may serve for different pieces of user equipment within a cell by flexibly using multiple beam widths and different beam directions, so as to improve an average throughput of the cell.

### Embodiment 3

An embodiment of this disclosure provides an apparatus for configuring a resource, configured in a base station of a 3D MIMO system. This embodiment corresponds to the method for configuring a resource of Embodiment 1, with identical contents being not going to be described herein any further.

FIG. 8 is a schematic diagram of a structure of the apparatus for configuring a resource of the embodiment of this disclosure. As shown in FIG. 8, the apparatus 800 for configuring a resource includes: a configuring unit 801 and an information transmitting unit 802.

The configuring unit 801 is configured to configure a first type of beams and a second type of beams having different beam widths; the first type of beams and the second type of beams are transmitted in resources of one or more reference signals, the reference signal being pre-coded by one or more weighting coefficients of a beam; and the information transmitting unit 802 is configured to broadcast beam configuration information to user equipment, the beam configuration information at least including identification information of a beam and physical resource information of the beam.

In this embodiment, the first type of beams may be wide beams having multiple different directions, and the second type of beams may be narrow beams having multiple different directions. And the reference signal may include one of the following signals or a combination thereof: a channel state information reference signal, a common reference signal, and a specific demodulation reference signal; however, this disclosure is not limited thereto, and it may be other reference signals used for measuring a channel by a terminal.

In an implementation, the multiple first type of beams employ identical physical resources, and the multiple second type of beams employ another group identical physical resources, the physical resources employed by the first type of beams being orthogonal to those employed by the second type of beams. The multiple first type of beams are differentiated by using different precoding information, and the multiple second type of beams are differentiated by using different precoding information.

The information transmitting unit 802 may further be configured to transmit the precoding information to the user equipment.

In another implementation, the multiple first type of beams and the multiple second type of beams employ different physical resources, physical resources occupied by different beams being orthogonal to each other.

In this embodiment, the information transmitting unit 802 may further be configured to transmit indication information to the user equipment via signaling, so as to indicate the user equipment to feed back according to a required feedback content.

As shown in FIG. 8, the apparatus 800 for configuring a resource may further include:

a feedback receiving unit 803 configured to receive feedback information transmitted by the user equipment, the feedback information being obtained by measuring the first type of beams and the second type of beams by the user equipment.

For example, the feedback information includes: channel state information of all the beams configured by the base station, and beam identification information to which each piece of the channel state information corresponds;

or, channel state information of a first type of beam with a best measurement result and corresponding beam identification information, and channel state information of a second type of beam with a best measurement result and corresponding beam identification information;

or, channel state information of a first type of beam with a best measurement result and corresponding beam identification information, and channel state information of multiple second type of beams with best measurement results and corresponding beam identification information;

or, channel state information of a first type of beam with a best measurement result and corresponding beam identification information, and average channel state information of multiple second type of beams.

As shown in FIG. 8, the apparatus 800 for configuring a resource may further include:

a scheduling unit 804 configured to perform scheduling according to feedback information transmitted by one or more pieces of the user equipment.

For example, the scheduling unit 804 may be configured to: serve for multiple pieces of user equipment by using the same beam if beam identification of the second type of beams fed back by the multiple pieces of user equipment is identical and beam identification of the first type of beams fed back by the multiple pieces of user equipment is also identical; in which orthogonal physical resources are used to differentiate the multiple pieces of user equipment;

serve for the multiple pieces of user equipment by using different first type of beams if beam identification of the second type of beams fed back by the multiple pieces of user equipment is identical and beam identification of the first type of beams fed back by the multiple pieces of user equipment is different;

serve for the multiple pieces of user equipment by using different second type of beams, or serve for the multiple pieces of user equipment by using the same first type of beam, if beam identification of the second type of beams fed back by the multiple pieces of user equipment is different and beam identification of the first type of beams fed back by the multiple pieces of user equipment is identical; in which orthogonal physical resources are used to differentiate the multiple pieces of user equipment;

and serve for the multiple pieces of user equipment by using different first type of beams, or serve for the multiple pieces of user equipment by using different second type of beam, if beam identification of the second type of beams fed back by the multiple pieces of user equipment is different and beam identification of the first type of beams fed back by the multiple pieces of user equipment is also different.

An embodiment of this disclosure further provides a base station, including the apparatus 800 for configuring a resource as described above.

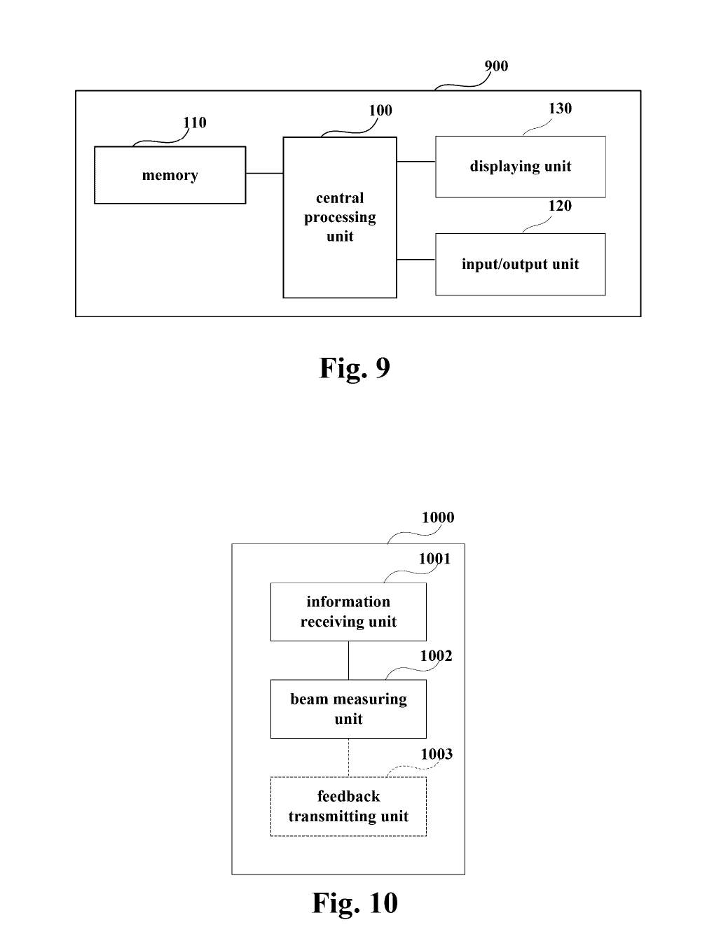

FIG. 9 is a schematic diagram of a structure of the base station of the embodiment of this disclosure. As shown in FIG. 9, the base station 900 may include a central processing unit (CPU) 100 and a memory 110, the memory 110 being coupled to the central processing unit 100. The memory 110 may store various data, and furthermore, it may store a program for information processing, and execute the program under control of the central processing unit 100.

In an implementation, the functions of the apparatus 800 for configuring a resource may be integrated into the central processing unit 100. The central processing unit 100 may be configured to carry out the method for configuring a resource as described in Embodiment 1.

In another implementation, the apparatus 800 for configuring a resource and the central processing unit 100 may be configured separately. For example, the apparatus 800 for configuring a resource may be configured as a chip connected to the central processing unit 100, with its functions being realized under control of the central processing unit 100.

Furthermore, as shown in FIG. 9, the base station 900 may further include an input/output unit 120, and a displaying unit 130, etc. Functions of the above components are similar to those in the relevant art, and shall not be described herein any further. It should be noted that the base station 900 does not necessarily include all the parts shown in FIG. 9, and furthermore, the base station 900 may include parts not shown in FIG. 9. And the relevant art may be referred to for a particular constitution of the base station.

It can be seen from the above embodiment that by configuring reference signal resources of multiple beam widths, multiple pieces of user equipment within the system may be served for by using multiple beam widths. Hence, the base station having multiple antennas may serve for different pieces of user equipment within a cell by flexibly using multiple beam widths and different beam directions, so as to improve an average throughput of the cell.

### Embodiment 4

An embodiment of this disclosure provides an apparatus for configuring a resource, configured in user equipment of a 3D MIMO system. This embodiment corresponds to the method for configuring a resource of Embodiment 2, with identical contents being not going to be described herein any further.

FIG. 10 is a schematic diagram of a structure of the apparatus for configuring a resource of the embodiment of this disclosure. As shown in FIG. 10, the apparatus 1000 for configuring a resource includes:

an information receiving unit 1001 configured to receive beam configuration information broadcasted by a base station, the beam configuration information at least including identification information of a beam and physical resource information of the beam; and

a beam measuring unit 1002 configured to measure a first type of beams and a second type of beams having different beam widths configured by the base station; the first type of beams and the second type of beams are transmitted in resources of one or more reference signals, the reference signal being pre-coded by one or more weighting coefficients of a beam.

As shown in FIG. 10, the apparatus 1000 for configuring a resource may further include:

a feedback transmitting unit 1003 configured to transmit feedback information to the base station, the feedback information being obtained by measuring the first type of beams and the second type of beams by the user equipment.

In this embodiment, the information receiving unit 1001 may further be configured to receive indication information transmitted by the base station via signaling; and the feedback transmitting unit 1003 may further transmit the feedback information according to a feedback content required by the indication information.

For example, the feedback information may include: channel state information of all the beams configured by the base station, and beam identification information to which each piece of channel state information corresponds;

or, channel state information of a first type of beams with a best measurement result and corresponding beam identification information, and channel state information of a second type of beams with a best measurement result and corresponding beam identification information;

or, channel state information of a first type of beams with a best measurement result and corresponding beam identification information, and channel state information of multiple second type of beams with best measurement results and corresponding beam identification information;

or, channel state information of a first type of beams with a best measurement result and corresponding beam identification information, and average channel state information of multiple second type of beams.

An embodiment of this disclosure further provides user equipment, including the apparatus 1000 for configuring a resource as described above.

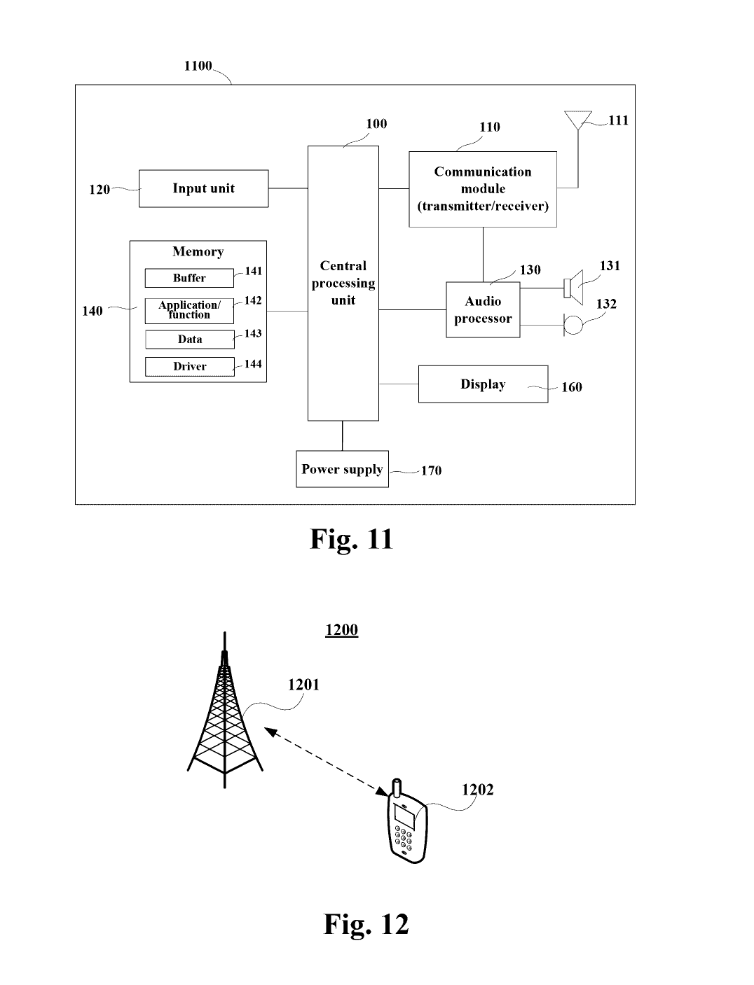

FIG. 11 is a schematic diagram of a structure of the user equipment of the embodiment of this disclosure. As shown in FIG. 11, the user equipment 1100 may include a central processing unit 1101 and a memory 1102, the memory 1102 being coupled to the central processing unit 1101. It should be noted that this figure is illustrative only, and other types of structures may also be used, so as to supplement or replace this structure and achieve telecommunications function or other functions.

In an implementation, the functions of the apparatus 1000 for configuring a resource may be integrated into the central processing unit 1101. The central processing unit 1101 may be configured to carry out the method for configuring a resource as described in Embodiment 1.

In another implementation, the apparatus 1000 for configuring a resource and the central processing unit 1101 may be configured separately. For example, the apparatus 1000 for configuring a resource may be configured as a chip connected to the central processing unit 1101, with its functions being realized under control of the central processing unit.

As shown in FIG. 11, the user equipment 1100 may further include a communications module 1103, an input unit 1104, an audio processor 1105, a display 1106 and a power supply 1107. It should be noted that the user equipment 1100 does not necessarily include all the parts shown in FIG. 11, and furthermore, the user equipment 1100 may include parts not shown in FIG. 11, and the relevant art may be referred to.

As shown in FIG. 11, the central processing unit 1101 is sometimes referred to as a controller or control, and may include a microprocessor or other processor devices and/or logic devices. The central processing unit 1101 receives input and controls operations of every components of the user equipment 1100.

The memory 1102 may be, for example, one or more of a buffer memory, a flash memory, a hard drive, a mobile medium, a volatile memory, a nonvolatile memory, or other suitable devices, which may store predefined or preconfigured information, and may further store a program executing related information. And the central processing unit 1101 may execute the program stored in the memory 1102, so as to realize information storage or processing, etc. Functions of other parts are similar to those of the relevant art, which shall not be described herein any further. The parts of the user equipment 1100 may be realized by specific hardware, firmware, software, or any combination thereof, without departing from the scope of the present disclosure.

It can be seen from the above embodiment that by configuring reference signal resources of multiple beam widths, multiple pieces of user equipment within the system may be served for by using multiple beam widths. Hence, the base station having multiple antennas may serve for different pieces of user equipment within a cell by flexibly using multiple beam widths and different beam directions, so as to improve an average throughput of the cell.

### Embodiment 5

An embodiment of this disclosure provides a communications system. FIG. 12 is a schematic diagram of a structure of the communications system of the embodiment of this disclosure. As shown in FIG. 12, the communications system 1200 includes:

a base station 1201 configured with the apparatus 800 for configuring a resource as described in Embodiment 3; and

user equipment 1202 configured with the apparatus 1000 for configuring a resource as described in Embodiment 4.

An embodiment of the present disclosure provides a computer readable program code, which, when executed in a base station, will cause a computer unit to carry out the method for configuring a resource as described in Embodiment 1 in the base station.

An embodiment of the present disclosure provides a computer readable medium, including a computer readable program code, which will cause a computer unit to carry out the method for configuring a resource as described in Embodiment 1 in a base station.

An embodiment of the present disclosure provides a computer readable program code, which, when executed in user equipment, will cause a computer unit to carry out the method for configuring a resource as described in Embodiment 2 in the user equipment.

An embodiment of the present disclosure provides a computer readable medium, including a computer readable program code, which will cause a computer unit to carry out the method for configuring a resource as described in Embodiment 2 in user equipment.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communications combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for configuring a resource, configured in a base station of a three-dimensional (3D) multiple input multiple output (MIMO) system, the apparatus comprising:
a configuring unit configured to configure a first type of beams and a second type of beams having different beam widths; wherein the first type of beams and the second type of beams are transmitted in resources of one or more reference signals, the reference signal being pre-coded by one or more weighting coefficients of a beam; and
an information transmitting unit configured to broadcast beam configuration information to user equipment, the beam configuration information at least comprising identification information of a beam and physical resource information of the beam.

2. The apparatus according to claim 1, wherein the first type of beams are multiple wide beams having different directions, and the second type of beams are multiple narrow beams having different directions;
and the reference signal comprises one of the following signals or a combination thereof: a channel state information reference signal, a common reference signal, and a demodulation reference signal.

3. The apparatus according to claim 1, wherein the multiple first type of beams employ identical physical resources, the multiple second type of beams employ identical physical resources, and the physical resources employed by the first type of beams are orthogonal to the physical resources employed by the second type of beams.

4. The apparatus according to claim 3, wherein the multiple first type of beams are differentiated by employing different precoding information, and the multiple second type of beams are differentiated by employing different precoding information;
and the information transmitting unit is further configured to transmit the precoding information to the user equipment.

5. The apparatus according to claim 1, wherein the multiple first type of beams and the multiple second type of beams employ different physical resources, physical resources occupied by different beams being orthogonal to each other.

6. The apparatus according to claim 1, wherein the information transmitting unit is further configured to transmit indication information to the user equipment via signaling, so as to indicate the user equipment to feed back according to a required feedback content.

7. The apparatus according to claim 1, wherein the apparatus further comprises:
a feedback receiving unit configured to receive feedback information transmitted by the user equipment, the feedback information being obtained by measuring the first type of beams and the second type of beams by the user equipment.

8. The apparatus according to claim 7, wherein the feedback information comprises: channel state information of all the beams configured by the base station, and beam identification information to which each piece of the channel state information corresponds;
or, channel state information of a first type of beam with a best measurement result and corresponding beam identification information, and channel state information of a second type of beam with a best measurement result and corresponding beam identification information;
or, channel state information of a first type of beam with a best measurement result and corresponding beam identification information, and channel state information of multiple second type of beams with best measurement results and corresponding beam identification information;
or, channel state information of a first type of beam with a best measurement result and corresponding beam identification information, and average channel state information of multiple second type of beams.

9. The apparatus according to claim 7, wherein the apparatus further comprises:
a scheduling unit configured to perform scheduling according to feedback information transmitted by one or more pieces of the user equipment.

10. The apparatus according to claim 9, wherein the scheduling unit is configured to:
serve for multiple pieces of user equipment by using the same beam if beam identification of the second type of beams fed back by the multiple pieces of user equipment is identical and beam identification of the first type of beams fed back by the multiple pieces of user equipment is also identical; wherein orthogonal physical resources are used to differentiate the multiple pieces of user equipment;
serve for the multiple pieces of user equipment by using different first type of beams if beam identification of the second type of beams fed back by the multiple pieces of user equipment is identical and beam identification of the first type of beams fed back by the multiple pieces of user equipment is different;
serve for the multiple pieces of user equipment by using different second type of beams, or serve for the multiple pieces of user equipment by using the same first type of beam, if beam identification of the second type of beams fed back by the multiple pieces of user equipment is different and beam identification of the first type of beams fed back by the multiple pieces of user equipment is identical; wherein orthogonal physical resources are used to differentiate the multiple pieces of user equipment; and
serve for the multiple pieces of user equipment by using different first type of beams, or serve for the multiple pieces of user equipment by using different second type of beam, if beam identification of the second type of beams fed back by the multiple pieces of user equipment is different and beam identification of the first type of beams fed back by the multiple pieces of user equipment is also different.

11. An apparatus for configuring a resource, configured in user equipment of a 3D MIMO system, comprising:
an information receiving unit configured to receive beam configuration information broadcasted by a base station, the beam configuration information at least comprising identification information of a beam and physical resource information of the beam; and
a beam measuring unit configured to measure a first type of beams and a second type of beams having different beam widths configured by the base station; wherein the first type of beams and the second type of beams are transmitted in resources of one or more reference signals, the reference signal being pre-coded by one or more weighting coefficients of a beam.

12. The apparatus according to claim 11, wherein the apparatus further comprises:
a feedback transmitting unit configured to transmit feedback information to the base station, the feedback information being obtained by measuring the first type of beams and the second type of beams by the user equipment.

13. The apparatus according to claim 12, wherein the information receiving unit is further configured to receive indication information transmitted by the base station via signaling;
and the feedback transmitting unit transmits the feedback information according to a feedback content required by the indication information.

14. The apparatus according to claim 12, wherein the feedback information comprises: channel state information of all the beams configured by the base station, and beam identification information to which each piece of channel state information corresponds;
or, channel state information of a first type of beams with a best measurement result and corresponding beam identification information, and channel state information of a second type of beams with a best measurement result and corresponding beam identification information;
or, channel state information of a first type of beams with a best measurement result and corresponding beam identification information, and channel state information of multiple second type of beams with best measurement results and corresponding beam identification information;
or, channel state information of a first type of beams with a best measurement result and corresponding beam identification information, and average channel state information of multiple second type of beams.

15. A communications system, comprising:
a base station configured with the apparatus of claim 1; and
user equipment configured with an apparatus for configuring a resource, the apparatus comprising:
an information receiving unit configured to receive beam configuration information broadcasted by a base station, the beam configuration information at least comprising identification information of a beam and physical resource information of the beam; and
a beam measuring unit configured to measure a first type of beams and a second type of beams having different beam widths configured by the base station; wherein the first type of beams and the second type of beams are transmitted in resources of one or more reference signals, the reference signal being pre-coded by one or more weighting coefficients of a beam.
